(19) United States
(12) Patent Application Publication
(10) Pub. No.: US 2008/0090966 A1
(43) Pub. Date: Apr. 17, 2008

(54) Immiscible polyurethane pultrusion formulations and processes

(76) Inventors: John E. Hayes, Gibsonia, PA (US); Albert Magnotta, Monaca, PA (US); Nigel Barksby, Moon Township, PA (US)

Correspondence Address: BAYER MATERIAL SCIENCE LLC, 100 BAYER ROAD, PITTSBURGH, PA, 15205, US

(21) Appl. No.: 11/546,882

(22) Filed: Oct. 12, 2006

(51) Int. Cl. C08F 8/30

(52) U.S. Cl. 525/123

(57) ABSTRACT

The present invention provides a reaction system for the preparation of a fiber reinforced composite according to the pultrusion process made from continuous fiber reinforcing material and an immiscible polyurethane formulation containing a polyisocyanate component including at least one polyisocyanate and an isocyanate-reactive component including at least one isocyanate-reactive compound. The inventive polyurethane formulations and improved pultrusion processes offer better processing and may yield better reinforced composites.

### FIELD OF THE INVENTION

The present invention relates in general to pultrusion, and more specifically, to immiscible polyurethane formulations and pultrusion processes utilizing such immiscible formulations.

### BACKGROUND OF THE INVENTION

Pultrusion is a manufacturing process for producing continuous lengths of fiber reinforced plastic (“FRP”) structural shapes. Raw materials include a liquid resin mixture (containing resin, fillers and specialized additives) and reinforcing fibers. The process involves pulling these raw materials, rather than pushing as is the case in extrusion, through a heated steel forming die using a continuous pulling device. The reinforcement materials are in continuous forms such as rolls of fiberglass mat or doffs of fiberglass roving. The two ways to impregnate, or “wet out”, the glass are open bath process and resin injection. Typical commercial resins include polyester, vinyl esters, phenolics, and epoxy compounds. These resins usually have very long gel times and can be run in an open bath process wherein the reinforcing fibers are soaked in a bath of resin and the excess resin is scraped off by a series of preform plates and at the die entrance. As the wetted fibers enter the die, the excess resin is squeezed through and off the reinforcing fibers. The pressure rise in the die inlet helps to enhance fiber wet-out and suppresses void formation. As the saturated reinforcements are pulled through the die, the gelation (or hardening) of the resin is initiated by the heat from the die and a rigid, cured profile is formed that corresponds to the shape of the die.

For resin systems like polyurethanes, which have a fast gel time and a short pot life the resin injection process is used. In the injection process, the reinforcement materials are passed through a small closed box which is usually attached to the die or may be part of the die. The resin is injected under pressure through ports in the box to impregnate the reinforcement materials. Resin injection boxes are designed to minimize resin volume and resin residence time inside the box. There are a number of different resin injection box designs in the literature all of which have the common features of an angled or tapered design and the exit profile matching the shape of the die entrance.

The patent art provides a number of teachings with respect to polyurethane pultrusion. For example, U.S. Pat. No. 6,420,493, issued to Ryckis-Kite et al., discloses a two component chemically thermoset composite resin matrix for use in composite manufacturing processes. The matrix includes a solvent-free polyisocyanate component and a solvent-free polyol component. The solvent-free polyisocyanate component is taught to be an aromatic polyisocyanate, an aliphatic polyisocyanate or a blend of both. The disclosed solvent-free polyol component is a polyether polyol, a polyester polyol or a blend of both. The polyisocyanate component and the polyol component are said to be in relative proportions in accordance with an OHINCO equivalent ratio of 1:1 to 1:2. Ryckis-Kite et al. require the presence of 10%-40% of a polyester polyol with the use of 5 to 20 wt % of a hydroxyl terminated vegetable oil is also being taught. For the isocyanate component, Ryckis-Kite et al. state that it is preferred to have at least 15 wt % of an aliphatic polyisocyanate.

Cheolas et al., in U.S. Pat. No. 6,793,855, teach polyisocyanurate systems, pultrusion of those systems to produce reinforced polyisocyanurate matrix composites, and the composites produced by that pultrusion. The polyisocyanurate systems of Cheolas et al. include a polyol component, an optional chain extender, and an isocyanate. The polyisocyanurate systems are said to have extended initiation times of about 5 minutes to about 30 minutes at room temperature and are capable of snap curing. Cheolas et al., at col. 8, lines 10-23, state that in one of their types of polyisocyanurate systems, Type I, the polyol, chain extender and isocyanate may be varied to control the miscibility of the reaction mixture and they provide several methods designed to increase miscibility of that mixture. The teaching of Cheolas et al. is that substantial polymerization of the polyurethane takes place in the impregnation die.

U.S. Pat. No. 7,056,976, in the name of Joshi et al., also discloses polyisocyanate-based reaction systems, a pultrusion process using those systems to produce reinforced matrix composites, and composites produced by that pultrusion process. The polyisocyanate-based systems are mixed activated reaction systems that include a polyol composition, an optional chain extender or crosslinker and a polyisocyanate. The polyisocyanate-based systems are said to exhibit improved processing characteristics in the manufacture of fiber reinforced thermoset composites via reactive pultrusion. Joshi et al. teach that gel times are the key parameter in polyurethane pultrusion.

In addition, Cheolas et al., in U.S. Published Patent Application No. 2004/0094859 A1, teach polyisocyanurate systems, pultrusion of those systems to produce reinforced polyisocyanurate matrix composites, and composites produced by that pultrusion process. The polyisocyanurate systems include a polyol component, an optional chain extender and an isocyanate. The polyisocyanurate systems are said to have extended initiation times of about 5 minutes to about 30 minutes at room temperature, and are capable of being snap cured. Cheolas et al., like Joshi et al., teach that gel times are the key parameter in polyurethane pultrusion processes.

A need therefore exists for improved polyurethane formulations for use in pultrusion processes to afford better processing and yield better reinforced composites.

### SUMMARY OF THE INVENTION

Accordingly, the present invention provides a reaction system for the preparation of a fiber reinforced composite according to the pultrusion process made from continuous fiber reinforcing material and an immiscible polyurethane formulation made from a polyisocyanate component containing at least one polyisocyanate and an isocyanate-reactive component containing at least one isocyanate-reactive compound. Also provided are improved pultrusion processes including the inventive polyurethane formulations that offer better processing and may yield better reinforced composites.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a reaction system for the preparation of a fiber reinforced composite according to the pultrusion process made from continuous fiber reinforcing material and an immiscible polyurethane formulation containing a polyisocyanate component including at least one polyisocyanate and an isocyanate-reactive component including at least one isocyanate-reactive compound.

The present invention further provides a pultrusion process for preparing a fiber reinforced polyurethane composite, the process involving continuously pulling a roving or tow of continuous fiber reinforcing material successively through an impregnation chamber and a die, continuously feeding an immiscible polyurethane formulation containing a polyisocyanate component including at least one polyisocyanate and an isocyanate-reactive component including at least one isocyanate-reactive compound to the impregnation chamber, contacting the fiber reinforcing material with the immiscible formulation in the impregnation chamber such that substantially complete wetting of the material by the formulation occurs, directing the fiber reinforcing material through a die heated to reaction temperature to form a solid composite, and drawing the composite from the die, wherein conditions in the impregnation chamber are such that substantially no polymerization takes place.

Heretofore, the teaching in the art regarding the miscibility of polyurethane forming components has been to improve the miscibility of the polyol-isocyanate mixture for pultrusion. The present inventors surprisingly have found that polyurethane formulations which are immiscible process better in pultrusion processes than do formulations that are miscible. More specifically, those formulations where: (a) the isocyanate-reactive compounds are less compatible, rather than more compatible with each other, or (b) where the isocyanate reactive component is less compatible with the isocyanate, i.e., where the polyurethane-forming formulation takes longer to clear or does not clear rather than clear rapidly; or (c) where the resulting polymer has a high degree of phase separation rather than a low degree, process better in pultrusion.

The miscibility of isocyanate-reactive component can be determined by allowing the compounds to rest unmixed after the component is made and see if the component becomes hazy or separates into layers. The miscibility of the isocyanate-reactive component with the polyisocyanate can be determined by mixing the isocyanate-reactive component with the polyisocyanate component and determining the time for the mixture to clear. The mixture is normally initially opaque and after reacting becomes clear or it may remain opaque. After the mixture solidifies, it may be clear and transparent indicating a high degree of phase miscibility or the mixture may be opaque and non transparent indicating a low degree of phase miscibility. The present inventors have found that isocyanate-reactive mixtures that 1) are hazy or separate on standing; and/or 2) take a long time to clear process better.

Those skilled in the polyurethane art will be familiar with methods to alter the compatibility of isocyanate-reactive compounds and polyisocyanates so as to provide a polymer with a high degree of phase separation. Preferably, this may accomplished by varying the molecular weights, compositions, and functionality of the isocyanate-reactive compounds in the isocyanate-reactive component. Because the addition of low molecular weight crosslinkers to a polyol blend increases its compatibility with the isocyanate and increases the phase miscibility of the polymer, adding high molecular weight isocyanate-reactive compounds to the inventive isocyanate-reactive component acts to decrease the compatibility with the polyisocyanate, thereby resulting in a more phase separated polymer.

Isocyanate-reactive compounds preferred in the present invention are polyols. Among the preferred types of polyols are polyether polyols and polyester polyols. Suitable polyether polyols that can be employed in the present invention include those prepared by reacting an alkylene oxide, a halogen substituted or aromatic substituted alkylene oxide or mixtures thereof, with an active hydrogen containing initiator compound.

Suitable polyols preferably have a number averaged functionality of organically bound primary or secondary alcohol groups of at least 1.8. In the present invention, the number averaged functionality of polyol preferably is from 1.8 to 10, more preferably from 1.9 to 8, and most preferably from 2 to 6. The isocyanate-reactive component contains predominantly, on a weight basis, a mixture of polyols.

In some embodiments of the invention, the isocyanate-reactive component preferably contains a mixture of two or more organic polyols. The individual polyols preferably differ principally in regard to hydroxyl group functionality and molecular weight. In particularly preferred embodiments of the invention, the organic polyols in the isocyanate-reactive component are chosen from softblock polyols, rigid polyols, chain extenders, crosslinkers, and combinations thereof.

Polyols, which furnish softblock segments, are known to those skilled in the art as softblock polyols, or as flexible polyols. Such polyols preferably have a number averaged molecular weight of at least 1,500 and more preferably from 1,750 to 8,000, a number averaged equivalent weight of preferably from 400 to 4,000, more preferably from about 750 to 2,500, and a number averaged functionality of isocyanate-reactive organic —OH groups of preferably 1.8 to 10 and more preferably from 2 to 4. Such compounds include, for example, aliphatic polyether or aliphatic polyester polyols containing primary and/or secondary hydroxyl groups. It is preferred in the present invention that such softblock polyols make up from 1 to 40% by weight and more preferably from 10 to 30% by weight of the isocyanate-reactive component. Preferred softblock polyols are liquid at 25° C.

Polyols that provide structural rigidity in the derived polymer are referred to in the art as rigid polyols and are a preferred class for inclusion in the inventive isocyanate-reactive component. Such polyols preferably have number averaged molecular weights of from 250 to 3,000, more preferably from 250 to less than 1,500; number averaged equivalent weights of preferably from 80 to 750, more preferably from 85 to 300; and number averaged isocyanate reactive group functionalities of preferably from 2 to 10, more preferably 2 to 4, and most preferably 2 to 3. Such compounds include, for example, polyether or polyester polyols containing primary and/or secondary hydroxyl groups. Preferred rigid polyols are also liquid at 25° C.

Suitable in the present invention are those polyols referred to the in the art as chain extenders and/or crosslinkers. Such polyols have molecular weights of 60 to less than 200 and isocyanate-reactive group functionalities of from 2 to 4, more preferably from 2 to 3. However, it is most preferred to minimize the amount or avoid chain extenders altogether in the present invention.

Examples of chain-extenders/crosslinkers are simple glycols and triols, such as ethylene glycol, propylene glycol, dipropylene glycol, 1,4-butanediol, 1,3-butanediol, triethanolamine, triisopropanolamine, tripropylene glycol, diethylene glycol, triethylene glycol, mixtures of these, and the like. The most preferred chain-extenders/crosslinkers are liquids at 25° C. Although aliphatic —OH functional compounds, such as those just listed, are the most preferred as chain-extenders/crosslinkers, it is within the scope of the invention to employ certain polyamines, polyamine derivatives, and/or polyphenols. Examples of suitable amines known in the art include diisopropanolamine, diethanolamine, and 3,5-diethyl-2,4-diaminotoluene, 3,5-diethyl-2,6-diaminotoluene and mixtures thereof. Examples of suitable isocyanate-reactive amine derivatives include certain imino-functional compounds, such as those described in EP 0 284,253 and EP 0 359,456 and certain enamino-functional compounds such as those described in EP 0 359, 456 having 2 or more isocyanate-reactive groups per molecule. Reactive amines, especially aliphatic primary amines, are less preferred due to extremely high reactivity with polyisocyanates, but may optionally be used if desired in minor amounts.

It is also within the scope of the invention, albeit less preferred, to include within the isocyanate-reactive component minor amounts of other types of isocyanate-reactive species that may not conform to the types described hereinabove.

Among the benefits of the inventive formulations are: (1) the pultruded parts have a smoother surface in some embodiments which prevents defects from arising on the finished surface, especially those parts. having complex profiles; (2) generally lower pull forces are required; (3) the pultrusion process can be stopped or paused for longer time periods without “locking up” in the die; (4) the pot life of the system is increased; and (5) the pultruded parts are lighter and more uniform in color.

Further, in contradistinction to the teaching in the art, exemplified by the patents mentioned hereinabove that require a high degree of polymerization occur within the impregnation die, the present inventors find it desirable to have essentially no reaction occur inside of the impregnation die. Although the gel time of all resins, not just polyurethanes, is important, the inventors herein have determined that it is not the key factor in determining pultrusion processability.

Pultrusion of the inventive polyurethane formulations to produce fiber reinforced composites is preferably performed by feeding the polyisocyanate and isocyanate-reactive components to a metering machine for delivery in a desired ratio to produce an immiscible polyurethane formulation. The immiscible polyurethane formulation is fed to an injection die where it impregnates fibers being pulled concurrently into the injection die. The conditions in the injection die are such that little, or more preferably no polymerization of the immiscible polyurethane formulation will occur. The resulting uncured composite is pulled through a zoned heating die, attached directly to the injection die, having a desired cross-section where it is shaped and cured. The dynamic forces needed to pull the composite through the forming die are provided by a pulling machine which has gripping devices that contact the cured composite profile (or the glass fibers therein) and give the traction necessary to pull the composite profile through the die. The machine may also have a device that develops a force in the desired direction of pull that gives the impetus necessary to pull the composite profile continuously through the die. The resulting composite profile upon exiting the pulling machine may be cut to the desired length, for example, by an abrasive cut off saw.

A long fiber based reinforcing material provides mechanical strength to the pultruded composite, and allows the transmission of the pulling force in the process. Fibers should preferably be at least long enough to pass though both the impregnation and curing dies and attach to a source of tension. The fibrous reinforcing material suitable in the instant invention may be any fibrous material or materials that can provide long fibers capable of being at least partially wetted by the immiscible polyurethane formulation during impregnation. The fibrous reinforcing structure may be single strands, braided strands, woven or non-woven mat structures, combinations of these, or the like. Mats or veils made of long fibers may be used, in single ply or multi-ply structures. Suitable fibrous materials known in the pultrusion art, include, but are not limited to, glass fibers, glass mats, carbon fibers, polyester fibers, natural fibers, aramid fibers, nylon fibers, basalt fibers, combinations thereof. Particularly preferred in the present invention are long glass fibers. The fibers and/or fibrous reinforcing structures may be formed continuously from one or more reels feeding into the pultrusion apparatus and attached to a source of pulling force at the outlet side of the curing die. The reinforcing fibers may optionally be pre-treated with sizing agents or adhesion promoters as is known in the art.

The weight percentage of the long fiber reinforcement in the pultruded composites of the present invention may vary considerably, depending on the end use application intended for the composite articles. Reinforcement loadings may be from 30 to 95% by weight, preferably from 40 to 90% by weight of the final composite, more preferably from 60 to 90% by weight, and most preferably from 70 to 90% by weight, based on the weight of the final composite. The long fiber reinforcement may be present in the pultruded composites produced in the present invention in an amount ranging between any combination of these values, inclusive of the recited values.

In some embodiments of the present invention, the polyisocyanate component and the isocyanate-reactive component may be the only components that are fed into the impregnation die in the pultrusion process. The polyisocyanate component or the isocyanate reactive composition may be premixed with any optional additives. However, it is to be understood that the optional additives that are not themselves polyfunctional isocyanate reactive materials are to be considered (counted) as entities separate from the isocyanate-reactive component, even when mixed therewith. Likewise, if the optional additives, or any part thereof, are premixed with the polyisocyanate component, these are to be considered as entities separate from the polyisocyanate component, except in the case where they are themselves polyfunctional isocyanate species.

The pultrusion apparatus preferably has at least one impregnation die and at least one curing die. Because no polymerization is to take place in the impregnation die, the curing die necessarily will operate at a higher temperature than the impregnation die. The pultrusion apparatus may optionally contain a plurality of curing dies, or zones. Different curing zones may be set at different temperatures, if desired, but all the zones of the curing die will be higher in temperature than the impregnation die. The pultrusion apparatus may optionally contain a plurality of impregnation dies. Preferably, there is just one impregnation die, and this preferably is situated immediately prior to the first curing die (or zone). As mentioned hereinabove, the impregnation die is set at a temperature that provides for substantially no reaction (polymerization) between the polyisocyanate component and the polyisocyanate-reactive component in the immiscible polyurethane formulation before the fibrous reinforcing structure, which has been at least partially impregnated with the immiscible polyurethane formulation, enters the first curing die (or zone).

Suitable polyisocyanates are known to those skilled in the art and include unmodified isocyanates, modified polyisocyanates, and isocyanate prepolymers. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula,

Q(NCO)ₙ

in which n is a number from 2-5, preferably 2-3, and Q is an aliphatic hydrocarbon group containing 2-18, preferably 6-10, carbon atoms; a cycloaliphatic hydrocarbon group containing 4-15, preferably 5-10, carbon atoms; an araliphatic hydrocarbon group containing 8-15, preferably 8-13, carbon atoms; or an aromatic hydrocarbon group containing 6-15, preferably 6-13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate; e.g. German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane-groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654,106; polyisocyanates containing ester groups of the type described, for example, in GB 965,474 and GB 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. Those skilled in the art will recognize that it is also possible to use mixtures of the polyisocyanates described above.

In general, it is preferred to use readily available polyisocyanates, such as 2,4- and 2,6-toluene diisocyanates and mixtures of these isomers (TDI); polyphenyl-polymethylene-polyisocyanates of the type obtained by condensing aniline with formaldehyde, followed by phosgenation (crude MDI); and polyisocyanates containing carbodiimide groups, urethane groups, allophanate groups, isocyanurate groups, urea groups, or biuret groups (modified polyisocyanates).

Isocyanate-terminated prepolymers may also be employed in the present invention. Prepolymers may be prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known to those skilled in the art. The use of any one specific active hydrogen compound is not critical; any such compound can be employed in the practice of the present invention.

The polyisocyanate component preferably contains organic polyisocyanates having a number averaged isocyanate (NCO) functionality of from at least 1.8 to 4.0, more preferably from 2.0 to 3.0, most preferably from 2.3 to 2.9. The NCO functionality of the polyisocyanate composition may be in an amount ranging between any combination of these values, inclusive of the recited values. The polyisocyanate composition preferably has a free isocyanate group content (NCO content) in the range of from 5% to 50% by weight, more preferably from 8% to 40%, most preferably from 9% to 35% by weight. The NCO content of the polyisocyanate composition may be in an amount ranging between any combination of these values, inclusive of the recited values.

The immiscible polyurethane formulation may optionally contain a catalyst for one or more of the polymer forming reactions of polyisocyanates. Catalyst(s), where used, is/are preferably introduced into the immiscible polyurethane formulation by pre-mixing with the isocyanate-reactive component. Catalysts for the polymer forming reactions of organic polyisocyanates are well known to those skilled in the art. Preferred catalysts include, but are not limited to, tertiary amines, tertiary amine acid salts, organic metal salts, covalently bound organometallic compounds, and combinations thereof.

Examples of preferred tertiary amine catalysts include triethylenediamine, N,N-dimethyl cyclohexylamine, bis (dimethylamino)-diethyl ether, N-ethyl morpholine, N,N,N′,N′,N″-pentamethyl diethylenetriamine, N,N-dimethyl aminopropylamine, N-benzyl dimethylamine, and aliphatic tertiary amine-containing amides of carboxylic acids, such as the amides of N,N-dimethyl aminopropylamine with stearic acid, oleic acid, hydroxystearic acid, and dihydroxylstearic acid.

Examples of suitable tertiary amine acid salt catalysts include those prepared by the at least partial neutralization of formic acid, acetic acid, 2-ethyl hexanoic acid, oleic acid, or oligomerized oleic acid with a tertiary amine such as triethylenediamine, triethanolamine, triisopropanolamine, N-methyl diethanolamine, N,N-dimethyl ethanolamine, mixtures thereof.

Examples of preferred organic metal salts for use as catalysts include potassium 2-ethyl hexanoate (potassium “octoate”), potassium oleate, potassium acetate, potassium hydroxide, bismuth octoate, zinc neodecanoate, dibutyltin dilaurate, dibutyltin diacetate, and dibutyltin dioleate, and other organotin carboxylate catalysts.

Other metal-based catalysts, which are suitable for use in the invention, include zinc carboxylates, such as zinc stearate and zinc neodecanoate, and bismuth carboxylates. Further examples of useful catalysts suitable in the present invention include amido amine compounds derived from the amidization reaction of N,N-dimethyl propanedimine with fatty carboxylic acids.

Mixtures of tertiary amine, amine acid salt, organometallic, and/or metal salt catalysts may be used. The use of mixed catalysts is well known to those skilled in the art. It is sometimes desirable to include in the mixing activated chemical formulation one or more catalysts for the trimerization of isocyanate groups.

The levels of the preferred catalysts required to achieve the needed reactivity profile for pultrusion will vary with the composition of the formulation and must be optimized for each formulation. Such optimization is understood by persons of skill in the art. The catalysts preferably have at least some degree of solubility in the isocyanate-reactive compounds used, and are most preferably fully soluble in the isocyanate-reactive component at the use levels required.

The inventive immiscible polyurethane formulation may contain other optional additives, if desired. These optional additives are preferably added to the isocyanate-reactive component prior to processing, although it is within the scope of the invention to premix all or any part of the optional additives package with the polyisocyanate component under the proviso that it does cause the polyisocyanate to self-react or otherwise interfere with pultrusion processing of the reaction system. Examples of additional optional additives include particulate or short fiber fillers, internal mold release agents, fire retardants, smoke suppressants, dyes, pigments, antistatic agents, antioxidants, UV stabilizers, minor amounts of viscosity reducing inert diluents, combinations of these, and any other known additives from the art. In some embodiments of the present invention, the additives or portions thereof may be provided to the fibers, such as by coating the fibers with the additive.

Internal mold release additives are highly preferred in pultrusion of mixing activated isocyanate based resins systems to prevent sticking or buildup in the die. Suitable internal mold release agents include, for example, fatty amides such as erucamide or stearamide, fatty acids such a oleic acid, oleic acid amides, fatty esters such as LOXIOL G71S inert polyester (from Henkel), carnuba wax, beeswax (natural esters), butyl stearate, octyl stearate, ethylene glycol monostearate, ethylene glycol distearate, glycerin di-oleate, glycerin tri-oleate, and esters of polycarboxylic acids with long chain aliphatic monovalent alcohols such as dioctyl sebacate, mixtures of (a) mixed esters of aliphatic polyols, dicarboxylic acids and long-chained aliphatic monocarboxylic acids, and (b) esters of the groups: (1) esters of dicarboxylic acids and long-chained aliphatic monofunctional alcohols, (2) esters of long-chained aliphatic monofunctional alcohols and long-chained aliphatic monofunctional carboxylic acids, (3) complete or partial esters of aliphatic polyols and long-chained aliphatic monocarboxylic acids, silicones such as TEGO IMR 412T silicone (from Goldschmidt), KEMESTER 5721 ester (a fatty acid ester product from Witco Corporation), fatty acid metal carboxylates such as zinc stearate and calcium stearate, waxes such as montan wax and chlorinated waxes, fluorine containing compounds such as polytetrafluoroethylene, fatty alkyl phosphates (both acidic and non acidic types such as ZELEC UN, ZELEC AN, ZELEC MR, ZELEC VM, ZELEC UN, ZELEC LA-1, and ZELEC LA-2 phosphates, which are all commercially available from Stepan Chemical Company), chlorinated-alkyl phosphates; hydrocarbon oils, combinations of these, and the like. Especially preferred internal mold release agents are TECHLUBE 550HB available from Technick Products and 1948MCH available from Axel Plastics.

Suitable fillers include, for example, aluminum trihydrate, antimony oxide, milled glass fibers, wollastonite, talc, mica, flaked glass, titanium dioxide, micronized polyethylene and combinations thereof.

Other preferred optional additives for use in pultrusion processing of polyurethanes include moisture scavengers, such as molecular sieves; defoamers, such as polydimethylsiloxanes; coupling agents, such as the mono-oxirane or organo-amine functional trialkoxysilanes; combinations of these and the like. The coupling agents are particularly preferred for improving the bonding of the matrix resin to the fiber reinforcement. Fine particulate fillers, such as clays and fine silicas, are often used at thixotropic additives. Such particulate fillers may also serve as extenders to reduce resin usage.

Fire retardants are sometimes desirable as additives in pultruded composites. Examples of preferred fire retardant types include, but are not limited to, triaryl phosphates; trialkyl phophates, especially those bearing halogens; melamine (as filler); melamine resins (in minor amounts); halogenated paraffins and combinations thereof.

The stoichiometry of mixing isocyanate-based polymer forming formulations, containing an organic polyisocyanate and a polyfunctional isocyanate reactive resin is often expressed by a quantity known in the art as the isocyanate index. The index of such a mixing activated formulation is simply the ratio of the total number of reactive isocyanate (—NCO) groups present to the total number of isocyanate-reactive groups (that can react with the isocyanate under the conditions employed in the process). This quantity is often multiplied by 100 and expressed as a percent. Preferred index values in the inventive formulations range from 70 to 150%. A more preferred range of index values is from 90 to 125%.

As those skilled in the art are aware, pultrusion of polyurethane and polyisocyanurate systems with fiber reinforced composites is performed by supplying the polyisocyanate and isocyanate-reactive components to a mix/metering machine for delivery in a desired ratio to a mixing apparatus, preferably a static mixer, to produce a reaction mixture. The reaction mixture is supplied to an injection die where it can be used to impregnate fibers being pulled concurrently into the injection die. The resulting uncured composite is pulled through a zoned heating die, attached directly to the injection die, having a desired cross-section where it is shaped and cured. The curing die has two to three heated zones equipped with electrical heating coils individually controlled to maintain the desired temperatures. The entrance to the die is cooled to prevent premature polymerization. The temperature at the hottest zone generally ranges from about 350° F. to about 450° F. The dynamic forces needed to pull the composite through the forming die are supplied by the pulling machine. This machine typically has gripping devices that contact the cured composite profile (or the glass fibers therein) and give the traction necessary to pull the composite profile through the die. The machine also has a device that develops a force in the desired direction of pull that gives the impetus necessary to pull the composite profile continuously through the die. The resulting composite profile upon exiting the pulling machine is then cut to the desired length typically by an abrasive cut off saw.

### EXAMPLES

The present invention is further illustrated, but is not to be limited, by the following examples. All quantities given in “parts” and “percents” are understood to be by weight, unless otherwise indicated. The following materials were used in the formulations of the examples:
POLYOL A an oxypropoxylated glycerol, nominal triol having a hydroxyl number of about 238 meq/g KOH, prepared by base catalysis;
POLYOL B an oxypropoxylated glycerol, nominal triol having a hydroxyl number of about 470 meq/g KOH, prepared by base catalysis;
POLYOL C an oxypropoxylated glycerol, nominal triol having a hydroxyl number of about 1050 meq/g KOH, prepared by base catalysis;
POLYOL D an oxypropoxylated propylene glycol, nominal diol having a hydroxyl number of about 28 meq/g KOH, prepared by double metal cyanide catalysis;
POLYOL E an oxypropoxylated propylene glycol, nominal diol having a hydroxyl number of about 56 meq/g KOH, prepared by double metal cyanide catalysis;
POLYOL F an oxypropoxylated glycerol, nominal triol having a hydroxyl number of about 28 meq/gmKOH, prepared by double metal cyanide catalysis;
MOLECULAR SIEVE a blend of a molecular sieve in oxypropoxylated glycerol, nominal triol having a hydroxyl number of about 28 meq/g KOH;
RELEASE AGENT an internal mold release agent available as TECHLUBE 550 HB from Technick Products;
CATALYST a tin catalyst available as FORMREZ UL 29 from GE Silicones; and
ISOCYANATE a liquid polymeric MDI product having a free isocyanate group content of about 31.4% by weight and a number averaged isocyanate group functionality of about 2.8.

The formulations in Table 1 were processed on several different commercial pultrusion machines with different-die profiles and found to process well over a range of speeds and temperatures compared to the comparative example. The inventive formulations yielded parts with better edge details on complex window lineal profiles, could be paused for long times without lockup, gave parts with a lighter color and smoother surface versus the comparative example.

TABLE 1

| Isocyanate-reactive component | Ex. C1 | Ex. 2 | Ex. 3 | Ex. 4 | Ex. 5 | Ex. 6 | Ex. 7 | Ex. 8 |
|---|---|---|---|---|---|---|---|---|
| POLYOL A | 40 | 30.00 | 20.00 | 20.00 | 45.00 | 15.00 | 30.00 | 30.00 |
| POLYOL B | 30 | 25.00 | 30.00 | 25.00 | 22.50 | 27.50 | 25.00 | 25.00 |
| POLYOL C | 30 | 25.00 | 30.00 | 35.00 | 22.50 | 27.50 | 25.00 | 25.00 |
| POLYOL D | 0 | 20.00 | 20.00 | 20.00 | 10.00 | 30.00 | | |
| POLYOL E | | | | | | | 20.00 | |
| POLYOL F | | | | | | | | 20.00 |
| MOLECULAR SIEVE | 4 | 4.000 | 4.00 | 4.00 | 4.00 | 4.00 | 4.00 | 4.00 |
| RELEASE AGENT | 4 | 4.000 | 4.00 | 4.00 | 4.00 | 4.00 | 4.00 | 4.00 |
| CATALYST | 0.7 | 0.700 | 0.70 | 0.70 | 0.70 | 0.70 | 0.70 | 0.70 |
| ISOCYANATE | 144.9 | 124.5 | 127.8 | 135 | 124.2 | 124.3 | 126 | 124.5 |
| Index | 110 | 114 | 105 | 105 | 115 | 112.5 | 114 | 114 |
| Polymer clarity | clear | opaque | opaque | opaque | opaque | opaque | opaque | opaque |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A reaction system for the preparation of a fiber reinforced composite according to the pultrusion process comprising:
continuous fiber reinforcing material; and
an immiscible polyurethane formulation comprising
a polyisocyanate component containing at least one polyisocyanate, and
an isocyanate-reactive component containing at least one isocyanate-reactive compound.

2. The reaction system according to claim 1, wherein the fiber reinforcing material is selected from the group consisting of single strands, braided strands, woven mat structures, non-woven mat structures and combinations thereof.

3. The reaction system according to claim 1, wherein the fiber reinforcing material comprises one or more of glass fibers, glass mats, carbon fibers, polyester fibers, natural fibers, aramid fibers, basalt fibers and nylon fibers.

4. The reaction system according to claim 1, wherein the fiber reinforcing material comprises glass fibers.

5. The reaction system according to claim 1, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane (“isophorone diisocyanate”), 2,4- and 2,6-hexahydrotoluene diisocyanate, dicyclohexylmethane-4,4′-diisocyanate (“hydrogenated MDI”, or “HMDI”), 1,3- and 1,4-phenylene diisocyanate, 2,4- and 2,6-toluene diisocyanate (“TDI”), diphenylmethane-2,4′- and/or -4,4′-diisocyanate (“MDI”), naphthylene-1,5-diisocyanate, triphenyl-methane-4,4′,4″-triisocyanate, polyphenyl-polymethylene-polyisocyanates (“crude MDI”), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret-containing polyisocyanates, isocyanate-terminated prepolymers and mixtures thereof.

6. The reaction system according to claim 1, wherein the at least one isocyanate-reactive compound is selected from the group consisting of softblock polyols, rigid polyols, chain extenders, crosslinkers and combinations thereof.

7. A pultrusion process for preparing a fiber reinforced polyurethane composite, the process comprising:
continuously pulling a roving or tow of continuous fiber reinforcing material successively through an impregnation chamber and a die;
continuously feeding an immiscible polyurethane formulation comprising a polyisocyanate component containing at least one polyisocyanate and an isocyanate-reactive component containing at least one isocyanate-reactive compound to the impregnation chamber;
contacting the fiber reinforcing material with the formulation in the impregnation chamber such that substantially complete wetting of the material by the formulation occurs;
directing the fiber reinforcing material through a die heated to reaction temperature to form a solid composite; and
drawing the composite from the die,
wherein conditions in the impregnation chamber are such that substantially no polymerization takes place.

8. The pultrusion process according to claim 7, wherein the fiber reinforcing material is selected from the group consisting of single strands, braided strands, woven mat structures, non-woven mat structures and combinations thereof.

9. The pultrusion process according to claim 7, wherein the fiber reinforcing material comprises one or more of glass fibers, glass mats, carbon fibers, polyester fibers, natural fibers, aramid fibers, basalt fibers and nylon fibers.

10. The pultrusion process according to claim 7, wherein the fiber reinforcing material comprises glass fibers.

11. The pultrusion process according to claim 7, wherein the at least one polyisocyanate is chosen from ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane (“isophorone diisocyanate”), 2,4- and 2,6-hexahydrotoluene diisocyanate, dicyclohexylmethane-4,4′-diisocyanate (“hydrogenated MDI”, or “HMDI”), 1,3- and 1,4-phenylene diisocyanate, 2,4- and 2,6-toluene diisocyanate (“TDI”), diphenylmethane-2,4′- and/or -4,4′-diisocyanate (“MDI”), naphthylene-1,5-diisocyanate, triphenyl-methane-4,4′,4″-triisocyanate, polyphenyl-polymethylene-polyisocyanates (“crude MDI”), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret-containing polyisocyanates, isocyanate-terminated prepolymers and mixtures thereof.

12. The pultrusion process according to claim 7, wherein the at least one isocyanate-reactive compound is selected from the group consisting of softblock polyols, rigid polyols, chain extenders, crosslinkers and combinations thereof.

13. The fiber reinforced polyurethane composite made by the process according to claim 7.

14. In a process for preparing a fiber reinforced polyurethane composite by pultrusion, the improvement comprising including a phase separated polyurethane formulation.

15. The process according to claim 14, wherein the phase separated polyurethane formulation comprises a polyisocyanate component containing at least one polyisocyanate and an isocyanate-reactive component containing at least one isocyanate-reactive compound.

16. The process according to claim 14, wherein the fiber reinforcing material is selected from the group consisting of single strands, braided strands, woven mat structures, non-woven mat structures and combinations thereof.

17. The process according to claim 14, wherein the fiber reinforcing material comprises one or more of glass fibers, glass mats, carbon fibers, polyester fibers, natural fibers, aramid fibers, basalt fibers and nylon fibers.

18. The process according to claim 14, wherein the fiber reinforcing material comprises glass fibers.

19. The process according to claim 14, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane (“isophorone diisocyanate”), 2,4- and 2,6-hexahydrotoluene diisocyanate, dicyclohexylmethane-4,4′-diisocyanate (“hydrogenated MDI”, or “HMDI”), 1,3- and 1,4-phenylene diisocyanate, 2,4- and 2,6-toluene diisocyanate (“TDI”), diphenylmethane-2,4′- and/or -4,4′-diisocyanate (“MDI”), naphthylene-1,5-diisocyanate, triphenyl-methane-4,4′,4″-triisocyanate, polyphenyl-polymethylene-polyisocyanates (“crude MDI”), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret-containing polyisocyanates, isocyanate-terminated prepolymers and mixtures thereof.

20. The process according to claim 14, wherein the at least one isocyanate-reactive compound is selected from the group consisting of softblock polyols, rigid polyols, chain extenders, crosslinkers and combinations thereof.
